(19) United States
(12) Patent Application Publication
(10) Pub. No.: US 2022/0289352 A1
(43) Pub. Date: Sep. 15, 2022

(54) A MARINE PROPELLER

(71) Applicant: CHAIRMAN, DEFENCE RESEARCH & DEVELOPMENT ORGANISATION (DRDO), New Delhi (IN)

(72) Inventors: Rama Krishna Varanasi, Visakhapatnam (IN); Venkata Satya Ganesh Kumar Pakki, Visakhapatnam (IN); Sankara Rao Challa, Visakhapatnam (IN); Suryanarayana Cheepurupalli, Visakhapatnam (IN); Bangaru Babu Popuri, Warangal (IN)

(21) Appl. No.: 17/638,246

(22) PCT Filed: Aug. 27, 2020
(86) PCT No.: PCT/IN2020/050749

§ 371 Date: Feb. 25, 2022

(30) Foreign Application Priority Data
Aug. 28, 2019 (IN) 201911034767

(51) Int. Cl. B63H 1/18; B63H 23/34; B63B 79/20

(52) U.S. Cl. CPC B63H 1/18; B63H 23/34; B63B 79/20

(57) ABSTRACT

A marine propeller having reduced noise characteristics, which has a hub having a central axis, one or more blades having blade length with a proximal end attached to the hub and a distal end extending radially outward from the hub, wherein the propeller has a diameter in between 360-400 mm, and wherein a combination of the diameter, pitch angle, skew angle, and number of blades of the propeller provides required thrust while generating low noise.

### FIELD OF THE INVENTION

The present invention mainly relates to the field of marine propeller and the reduction of propeller noise.

### BACKGROUND OF THE INVENTION

A propeller is well known in the art, which is a type of fan that transmits power by converting rotational motion into thrust. A pressure difference is produced between the forward and rear surfaces of an airfoil-shaped blade, and a fluid (such as air or water) is accelerated behind the blade. Most marine propellers are screw propellers with fixed helical blades rotating around a horizontal (or nearly horizontal) axis or propeller shaft.

Propeller noise consists of discrete frequencies (tonal frequencies) superimposed on a broadband spectrum. The propeller noise is due to complex interaction of the propeller with the fluid. Propeller noise has been studied by various researchers, but the prediction approaches are varied from complex analytical formulations to empirical estimations. Even though computational methods predict noise with given geometry, for every variation in design parameters such as number of blades and pitch of blade, the entire process of modeling and solving is to be repeated. The underwater radiated noise from the propeller is crucial, and reduction of propeller noise is essential for enhancing the stealth technology.

Therefore, there is a need in the art for a propeller and propeller noise prediction approach to solve the above-mentioned limitations.

### Objectives of the Invention

The main objective of the present invention is to optimize the design parameters of the propeller (especially pitch angle and number of blades of propeller) to reduce the noise levels. Another objective of the present invention is to develop a fuzzy logic model for the prediction of propeller noise for several possible combinations of influencing parameters.

### SUMMARY OF THE INVENTION

An aspect of the present invention is to address the above-mentioned problems and/or disadvantages and to provide at least the advantages described below.

Accordingly, in one aspect, the present invention relates to a propeller comprising: a hub having a central axis, one or more blades having blade length with a proximal end attached to the hub and a distal end extending radially outward from the hub, wherein the propeller has a diameter in between 360-400 mm, wherein a combination of the diameter, pitch angle, skew angle, and number of blades of the propeller provides required thrust and generates low noise. Other aspects, advantages, and salient features of the invention will become apparent to those skilled in the art from the following detailed description, which taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings in which:

FIG. 1 depicts four different perspective views of a solid model of a propeller according to one embodiment of the present invention.

FIG. 2 depicts front and rear cross-sectional perspective views of the propeller hub according to one embodiment of the present invention.

FIG. 3 depicts a radius, thickness, skew, and pitch angle of propeller, respectively, according to one embodiment of the present invention.

FIG. 4 shows a propeller under testing in a cavitation tunnel according to one embodiment of the present invention.

FIG. 5 shows a solid model of a low noise propeller with 6 blades and +5-degree pitch angle according to one embodiment of the present invention.

FIG. 6 shows a main effects plot for means in Taguchi method according to one embodiment of the present invention.

FIG. 7 shows a response optimizer graph for response surface methodology according to one embodiment of the present invention.

FIG. 8 shows a solid model of a 6 bladed, 365 mm diameter propeller (an optimized propeller) according to one embodiment of the present invention.

FIG. 9 shows an interpolated data in fuzzy logic system according to one embodiment of the present invention.

FIG. 10 shows an extrapolated data calculated from a fuzzy logic system according to one embodiment of the present invention.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure.

Throughout the drawings, it should be noted that like reference numbers are used to depict the same or similar elements, features, and structures.

### DETAILED DESCRIPTION OF THE PREFERRED EMBODIMENTS

The following description with reference to the accompanying figures is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings but are merely used by the inventor to enable a clear and consistent understanding of the invention. Accordingly, it should be apparent to those skilled in the art that the following descriptions of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Figures discussed below, and the various embodiments used to describe the principles of the present disclosure in this patent document, are by way of illustration only and should not be construed in any way that would limit the scope of the disclosure. Those skilled in the art will understand that the principles of the present disclosure may be implemented in any suitably arranged system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

The present invention focuses on propeller noise, its quantification and minimization. Generally, the propeller noise depends upon parameters such as the number of blades, pitch angle, skew angle, thickness of blade, blade area and diameter of propeller. The present invention optimizes the certain design parameters of the propeller (especially pitch angle and number of blades of propeller) to reduce the noise levels. Though the propeller generates the required thrust for forward motion, it also generates noise due to the fluid structure interaction.

Generally, the noise levels increase with an increase in the RPM of the propeller, as well as with an increase in flow velocity. Noise levels are estimated/predicted either by using basic equations of fluid dynamics or by computationally using computation fluid dynamics (CFD). This estimation can be measured experimentally; however, it is an expensive and time consuming to conduct experiments for all the possible configurations.

The power of propulsion machinery is transmitted to the propeller through the propeller shaft which is in turn fitted to the boss of the propeller. Then, a torque is developed on the propeller, which rotates the propeller about its axis, so that thrust is produced, which moves the vehicle in forward direction. Because of the pressure difference between the inlet and outlet of the blades, momentum is exchanged between the blades and the fluid which surrounds propeller. Thus, the mechanical energy available with the propeller is converted to static and kinetic energy of the fluid.

Generally, the propeller noise depends upon parameters like the number of blades, pitch angle, skew angle, thickness of blade, blade area, diameter of propeller, etc. Most of the parameters of the propeller are influencing the noise levels.

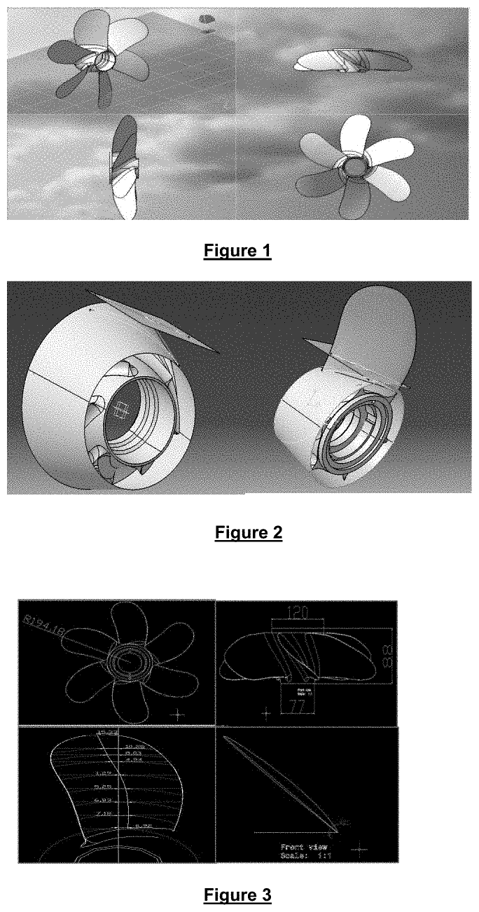

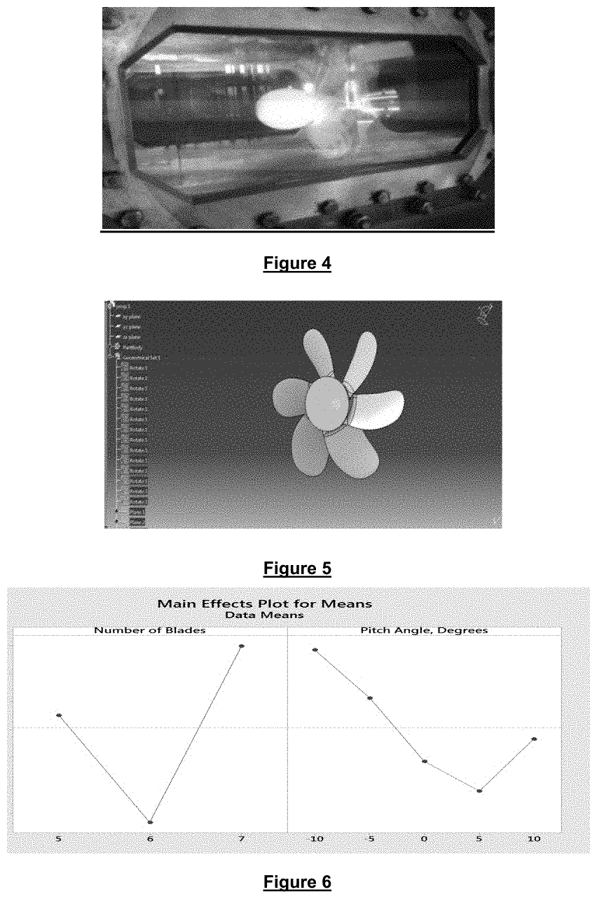

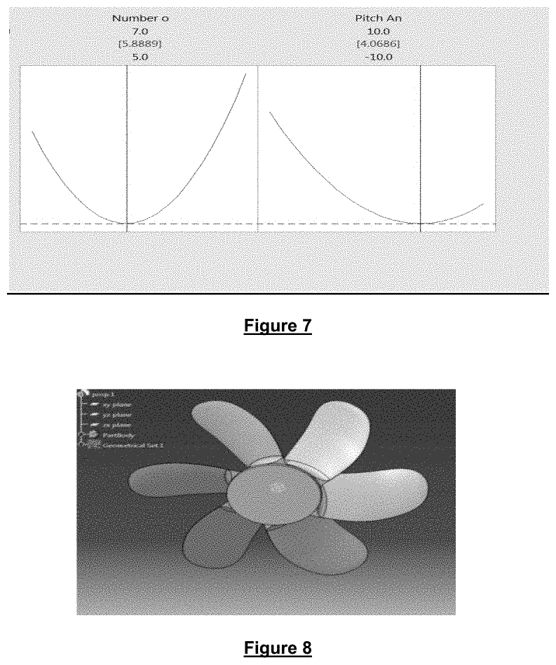

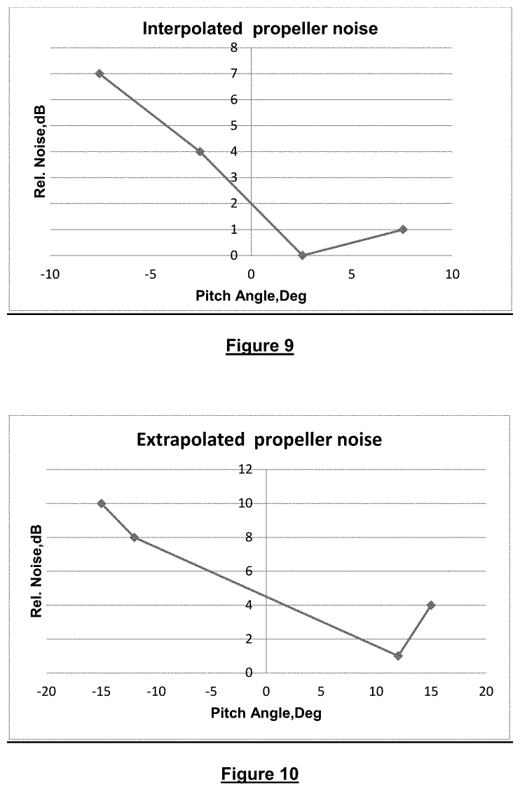

FIG. 1 shows perspective views of a solid model of a propeller according to one embodiment of the present invention.

In one embodiment, the present invention relates to a propeller comprising: a hub having a central axis, one or more blades having blade length with a proximal end attached to the hub and a distal end extending radially outward from the hub, wherein the propeller has a diameter in the range of 360 mm-400 mm, wherein a combination of the diameter, pitch angle, skew angle, and number of blades of the propeller provides required thrust and generates low noise.

The FIG. 2 shows a cutting section of the propeller. FIG. 3 shows geometric parameters radius, thickness, skew and pitch angle of the propeller.

Major Parameters Influencing the Propeller Noise

There are several parameters influencing the propeller noise in one way or other way. A brief description of the two major parameters that influence propeller noise is presented in the following section.

Number of Blades

Generally, a propeller contains a number of blades. The propeller mainly depends upon the level of unsteady forces acting on it. The optimum open water efficiency of a propeller increases with an increase in the number of blades up to a certain limit. So, it is essentially required to finalize the optimum number of blades. Lower numbers of blades are selected due to lower resistance, but higher diameter is recommended to get the required blade area for an effective thrust. A higher number of blades, generally 5 or above, is useful due to larger blade area with smaller diameters. In addition, closer blades create more turbulence than open blades, which automatically cancels each other's water flow. Generally, a higher number of blades is also used to reduce the vibration developed due to/by a change of pressure which creates a push. Higher vibrations lead to higher noise levels. In the present invention, four to seven number of blades are attached to the hub of the propeller. In at least one embodiment, the number of blades of the propeller is about 6 with the blades of the propeller having a diameter in the range of about 350 mm-400 mm, and a length of about 130 mm-145 mm. In an embodiment, the diameter and the length of the propeller blade is of about 389 mm (diameter) and length of about 137.5 mm. The thickness of blade of the propeller is in the range of about 8.69 to 0.33 mm and the blade area ratio of the propeller is in the range of about 0.70-0.90, where in at least one embodiment, the blade area ratio of the propeller is in the range of about 0.78.

The hub of the propeller is coupled to a propeller shaft, wherein the propeller shaft transmits a power of propulsion to the hub of the propeller, and a torque is developed, which rotates the propeller about its axis, thus thrust is produced which moves the vehicle in a forward direction.

Pitch Angle

Noise generation of a propeller also depends upon the pitch angle of the propeller. Pitch angle is neither high nor low, but it should be optimum with respect to the rpm level to avoid higher noise levels. There are different varieties of propellers with variable pitch angles designed for low noise. A controllable-pitch angle propeller (CPP) or variable-pitch angle propeller is a type of propeller, in which the pitch angle of propeller varies according to the flow velocity requirements.

In the present invention, the propeller noise variation is examined with respect to the variations of pitch angle and number of blades. Also, further study is carried out and analyzed for propeller performance. A fuzzy logic model is developed for prediction of the propeller noise by interpolating (in-between) and extrapolating (beyond) input parameters with the available data. The propeller has a pitch angle in the range of about +46° to +29°, in specific cases +5°, +10°, −5°, −10° of existing pitch angle, and the number of blades of the propeller is in the range between 5-7, and in specific cases, six blades.

In another embodiment, the present invention relates to a method of predicting propeller noise. The method comprises predicting non-cavitating propeller induced noise of at least one configuration of a propeller by CFD analysis, measuring the propeller noise of at least one configuration of the propeller using a cavitation tunnel and reviewing an effect of propeller design parameters (e.g., number of blades, pitch angle) using Taguchi and RSM techniques of at least one configuration of the propeller. The method steps are repeated for different configurations (varying parameters) of the propeller.

The noise prediction of the propeller is carried out using CFD and acoustic analysis. For the same propeller, noise measurements are carried out in a cavitation tunnel and validates experimentally measured noise. By using the same prediction method, noise estimations are made with varying pitch angle (−10 deg to +10 deg with variation of 5 deg of existing propeller) and number of blades (5, 6 and 7). From the experiment, it emerges that propeller with 6 blades and +5 deg pitch angle provides the lowest noise among the studied configurations with higher thrust and torque than required.

Prediction of the Propeller Noise

In the present invention, the non-cavitation underwater propeller noise is analytically estimated using Computational Fluid Dynamic models (CFD). A solid model is generated for the marine propeller and a CFD analysis using Large Eddy Simulation is carried out to find the pressure outputs. The thrust and torque are also found in the CFD Analysis. The output from the CFD analysis is used to carry out acoustic analysis using the Ffowcs Williams-Hawkings (FW-H) equation for finding the sound pressure levels. The intended aim of the present invention is accomplished by carrying out the analysis on a propeller consisting of six blades.

Experimental Measurement of the Propeller Noise

In the present invention, the propeller noise is measured through experimentation by using an acoustic measurement system in a cavitation tunnel. An experiment is conducted on a 6-bladed propeller, and non-cavitation noise of the propeller is evaluated for the same speed and flow velocity of the propeller configuration used for prediction. FIG. 4 shows a propeller under testing in a cavitation tunnel according to one embodiment of the present invention. The predicted results are validated with experimental results and it paved a way to carry out further studies on the propeller noise reduction.

Reduction of the Propeller Noise

Propeller noise can be reduced by various approaches, geometric modification being one of them. In the present invention, propeller geometry modifications are carried out by changing the pitch angle and number of propeller blades. The effect of changing the pitch angle and changing the number of blades on propeller noise is analyzed using CFD and acoustic analysis. FIG. 5 shows a solid model of low noise propeller (6 blades, +5-degree pitch angle with 389 mm diameter) out of the all variations studied according to one embodiment of the present invention.

Using Taguchi experimental design, the pitch angle and number of blades of propeller are used as input parameters, and the propeller noise is used as output parameter. The optimized influential parameter combination is obtained for optimized propeller noise. This obtained optimized influential parameter combination matches well with the parameters of predicted optimized propeller noise. FIG. 6 shows a main effects plot for means in the Taguchi method according to one embodiment of the present invention, depicting the main effects plot for means for the number of blades, and pitch angle (in degrees).

In Response Surface Methodology (RSM), optimized propeller noise is obtained after analysis of optimized input parameters like number of blades and pitch angle. FIG. 7 shows a response optimizer graph for Response Surface Methodology according to one embodiment of the present invention, depicting number of blades and pitch angle.

However, as the main function of the propeller for the configured vehicle is to generate the required thrust and torque, the low noise propeller is verified for the same. As the analysis showed the thrust and torque of low noise propeller are higher than required, diameter of the propeller is computed to maintain requisite thrust and torque. For this propeller, noise is computed again using CFD and acoustic analysis. FIG. 8 shows a solid model of optimized propeller (6 blades, +5-degree pitch angle with reduced diameter of 365 mm) according to one embodiment of the present invention. Therefore, an optimum design of the propeller with less noise and the required thrust is attained in this invention.

Development of a Fuzzy Logic Model

The methodology for predicting the marine propeller noise is cumbersome and time consuming. In the present invention, a methodology based on fuzzy logic model is presented for reducing noise prediction time with varying design parameters.

By using a Fuzzy Logic system, the propeller noise for interpolating (in-between) and extrapolating (beyond) input parameters are found with the available data. A methodology for predicting propeller noise using Fuzzy logic is established and developed. FIG. 9 depicts interpolated propeller noise for any pitch angle and any number of blades within specified range of the input parameters. FIG. 10 depicts extrapolated propeller noise for any pitch angle and any number of blades beyond specified range of the input parameters.

The present invention aims at reducing the non-cavitation propeller noise. The present invention has been carried out in different phases. In first phase, prediction of non-cavitating propeller induced noise has been studied. In this methodology, large eddy simulation method has been used in CFD analysis and the FW-H method has been used in acoustic analysis. In a second phase, the propeller noise levels have been measured experimentally in a cavitation tunnel. The theoretical model has been verified with experimental results. The noise levels obtained in experimentation and through the theoretical model are in good pact. This validates the establishment of theoretical model for noise prediction.

In third phase, the influence of propeller design parameters namely the pitch angle and number of blades has been studied. For this purpose, predictions have been carried out for fifteen different configurations of the propeller. In a preferred embodiment, a propeller with 6 blades and +five-degree pitch angle has been found to produce the lowest noise level. The same has been verified using Design of Experiments using Taguchi and RSM techniques. This propeller with 6 blades and +5-degree pitch angle has been further analyzed for Thrust and Torque. The configuration has been modified by reducing the propeller diameter to tune the thrust and torque to the originally specified level. The theoretical prediction has been carried out for the revised propeller design, which resulted in further reduction in noise levels. With available data of studied propeller configurations, interpolation and extrapolation of propeller noise has been carried out using Fuzzy Logic. A viable approach has been proposed to reduce the noise level of a Marine propeller by fine tuning the design parameters in order to meet demands of low noise.

Figures are merely representational and are not drawn to scale. Certain portions thereof may be exaggerated, while others may be minimized. Figures illustrate various embodiments of the invention that can be understood and appropriately carried out by those of ordinary skill in the art.

In the foregoing detailed description of embodiments of the invention, various features are grouped together in a single embodiment for the purpose of streamlining the disclosure. This device or unit or arrangement of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the detailed description of embodiments of the invention, with each claim standing on its own as a separate embodiment.

It is understood that the above description is intended to be illustrative, and not restrictive. It is intended to cover all alternatives, modifications and equivalents as may be included within the spirit and scope of the invention as defined in the appended claims. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Thus, having described the invention, what is claimed is:

1. A propeller comprising:
a hub having a central axis;
one or more blades having blade length with a proximal end attached to the hub and a distal end extending radially outward from the hub, wherein the propeller has a diameter in between 360-400 mm;
wherein a combination of the diameter, pitch angle, skew angle, number of blades of the propeller provides required thrust and generates low noise.

2. The propeller as claimed in claim 1, wherein the diameter of the propeller is about 389 mm.

3. The propeller as claimed in claim 1, wherein the propeller has a pitch angle in between about +46° to +29° pitch angle.

4. The propeller as claimed in claim 1, wherein the number of blades of the propeller is about 6, where the blades of the propeller having a diameter of about 389 mm and length of about 137.5 mm.

5. The propeller as claimed in claim 1, wherein the thickness of blade of the propeller is in the range of about 8.69 mm to 0.33 mm and the blade area ratio of the propeller is in the range of about 0.78.

6. The propeller as claimed in claim 1, wherein the four to seven number of blades are attached to the hub of the propeller.

7. The propeller as claimed in claim 1, wherein the hub of the propeller is coupled to a propeller shaft, wherein the propeller shaft transmits a power of propulsion to the hub of the propeller and a torque is developed, which rotates the propeller about its axis, thus thrust is produced which moves a vehicle in a forward direction.

8. A method of predicting a propeller noise using a fuzzy logic system, the method comprising:
predicting non-cavitating propeller induced noise of at least one configuration of a propeller by CFD analysis;
measuring the propeller noise of said at least one configuration of the propeller using cavitation tunnel; and
reviewing an effect of propeller design parameters including a number of blades and pitch angle using Taguchi and RSM techniques of said at least one configuration of the propeller.

9. The method as claimed in claim 8, wherein the method steps are repeated for different configurations including varying parameters of the propeller.
